(19) United States
(12) Patent Application Publication
(10) Pub. No.: US 2026/0134564 A1
(43) Pub. Date: May 14, 2026

(54) INFORMATION PROCESSING SYSTEM, INFORMATION PROCESSING METHOD, AND NON-TRANSITORY RECORDING MEDIUM

(71) Applicant: NEC Corporation, Minato-ku, Tokyo (JP)

(72) Inventor: Soma TAHARA, Tokyo (JP)

(73) Assignee: NEC Corporation, Minato-ku, Tokyo (JP)

(21) Appl. No.: 19/119,207

(22) PCT Filed: Oct. 14, 2022
(86) PCT No.: PCT/JP2022/038400

§ 371 Date: Apr. 8, 2025

(51) Int. Cl. G06T 7/70; G06V 40/60; H04N 23/60

(52) U.S. Cl. CPC G06T 7/70; G06T 2207/30201; G06V 40/60; H04N 23/64

(57) ABSTRACT

An information processing system includes: an acquisition unit that acquires a target image including a face of a target person; a generation unit that generates first guide information indicating a current position of the face of the target person and second guide information indicating a current angle of the face of the target person, based on the target image; and a display unit that displays third guide information indicating a target position of the face of the target person and fourth guide information indicating a target angle of the face of the target person, together with the first guide information and the second guide information. According to the information processing system, an image can be captured after properly adjusting the position and angle of the face.

### TECHNICAL FIELD

The present disclosure relates to technical fields of an information processing system, an information processing method, and a recording medium.

### BACKGROUND ART

A known system of this type outputs predetermined guide information when a face image is captured. For example, Patent Literature 1 discloses that an image in which a user's face is captured, is displayed with a guide for a position of the face. Patent Literature 2 discloses that an instruction image for guiding a user's face direction into a target direction after moving the user to a target position. Patent Literature 3 discloses displaying a registered progress meter extending radially outward from a user's face image.

### CITATION LIST

### Patent Literature

Patent Literature 1: JP2020-091876A

Patent Literature 2: JP2019-212156A

Patent Literature 3: JP2019-204494A

### SUMMARY

### Technical Problem

The present disclosure aims to improve the techniques/technologies disclosed in Citation List.

### Solution to Problem

An information processing system according to an example aspect of the present disclosure includes: an acquisition unit that acquires a target image including a face of a target person; a generation unit that generates first guide information indicating a current position of the face of the target person and second guide information indicating a current angle of the face of the target person, based on the target image; and a display unit that displays third guide information indicating a target position of the face of the target person and fourth guide information indicating a target angle of the face of the target person, together with the first guide information and the second guide information.

An information processing method according to an example aspect of the present disclosure includes: acquiring a target image including a face of a target person; generating first guide information indicating a current position of the face of the target person and second guide information indicating a current angle of the face of the target person, based on the target image; and displaying third guide information indicating a target position of the face of the target person and fourth guide information indicating a target angle of the face of the target person, together with the first guide information and the second guide information.

A recording medium according to an example aspect of the present disclosure is a recording medium on which a computer program that allows at least one computer to execute an information processing method is recorded, the information processing method including: acquiring a target image including a face of a target person; generating first guide information indicating a current position of the face of the target person and second guide information indicating a current angle of the face of the target person, based on the target image; and displaying third guide information indicating a target position of the face of the target person and fourth guide information indicating a target angle of the face of the target person, together with the first guide information and the second guide information.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a block diagram illustrating a functional configuration of an information processing system according to a second example embodiment.

FIG. 5 is a flowchart illustrating a flow of operation of the information processing system according to the second example embodiment.

FIG. 6 is a plan view illustrating an example of guide information in an information processing system according to a third example embodiment.

FIG. 7 is a plan view illustrating an example of guide information in an information processing system according to a fourth example embodiment.

FIG. 8 is a plan view illustrating an example of guide information in an information processing system according to a fifth example embodiment.

FIG. 9 is version 1 of a plan view illustrating an example of guide information in an information processing system according to a sixth example embodiment.

FIG. 10 is version 2 of a plan view illustrating an example of the guide information in the information processing system according to the sixth example embodiment.

FIG. 11 is a flowchart illustrating a flow of operation of an information processing system according to a seventh example embodiment.

FIG. 12 is a plan view illustrating a display example of guide information in an information processing system according to an eighth example embodiment.

FIG. 13 is version 1 of a plan view illustrating display examples of guide information in an information processing system according to a ninth example embodiment.

FIG. 14 is version 2 of a plan view illustrating display examples of the guide information in the information processing system according to the ninth example embodiment.

FIG. 15 is a plan view illustrating a display example of guide information in an information processing system according to a tenth example embodiment.

FIG. 16 is a plan view illustrating a display example of guide information in an information processing system according to an eleventh example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

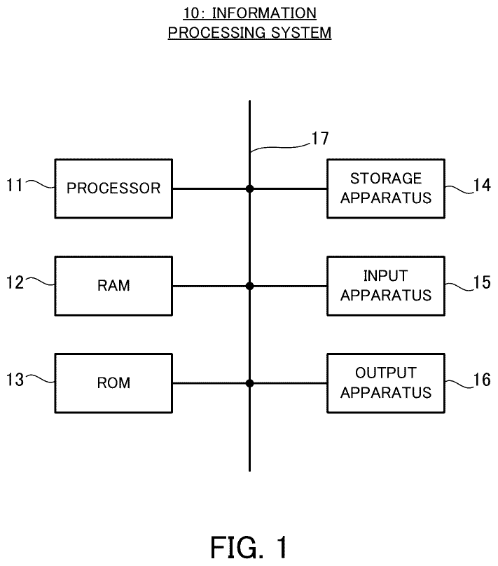

An information processing system according to a first example embodiment will be described with reference to FIG. 1 to FIG. 3.

### Hardware Configuration

First, with reference to FIG. 1, a hardware configuration of the information processing system according to the first example embodiment will be described. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected via a data bus 17.

The processor 11 reads a computer program. For example, the processor 11 is configured to read a computer program stored by at least one of the RAM 12, the ROM 13, and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for displaying guide information when a face image is captured, is realized in the processor 11. That is, the processor 11 may function as a controller for executing each control in the information processing system 10.

The processor 11 may be configured as, for example, a CPU (Central Processing Unit), a GPU (Graphics Processing Unit), a FPGA (field-programmable gate array), a DSP (Demand-Side Platform), an ASIC (Application Specific Integrated Circuit), or a quantum processor. The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used in place of the RAM 12.

The ROM 13 stores the computer program to be executed by the processor 11. The ROM 13 may also store fixed data. The ROM 13 may be, for example, a P-ROM (Programmable Read Only Memory) or an EPROM (Erasable Read Only Memory). Furthermore, another type of non-volatile memory may also be used in place of the ROM 13.

The storage apparatus 14 stores data that are stored by the information processing system 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may be a speaker or the like that is configured to audio-output the information about the information processing system 10. The outputting apparatus 16 may be configured as a portable terminal such as a smartphone and a tablet. The output apparatus 16 may be an apparatus that outputs information in a format other than an image. For example, the output apparatus 16 may be a speaker that audio-outputs the information about the information processing system 10.

Although FIG. 1 illustrates the information processing system 10 including a plurality of apparatuses, all or a part of the functions may be realized in a single apparatus (an information processing apparatus). In such a case, the information processing apparatus may include, for example, only the processor 11, the RAM 12, and the ROM 13. The other components (i.e., the storage apparatus 14, the input apparatus 15, and the output apparatus 16) may be provided in an external apparatus connected to the information processing apparatus. In addition, in the information processing apparatus, a part of an arithmetic function may be realized by an external apparatus (e.g., an external server or cloud, etc.).

### Functional Configuration

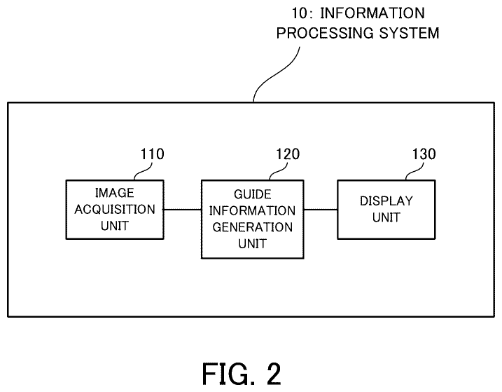

Next, with reference to FIG. 2, a functional configuration of the information processing system 10 according to the first example embodiment will be described. FIG. 2 is a block diagram illustrating the functional configuration of the information processing system according to the first example embodiment.

As illustrated in FIG. 2, the information processing system 10 according to the first example embodiment includes, as components for realizing the functions thereof, an image acquisition unit 110, a guide information generation unit 120, and a display unit 130. Each of the image acquisition unit 110, the guide information generation unit 120, and the display unit 130 may be a processing block realized by the processor 11 (see FIG. 1), for example.

The image acquisition unit 110 is configured to acquire an image including a face of a target person (hereinafter referred to as a “target image” as appropriate). This target image may be, for example, am image used for biometric authentication. The image acquisition unit 110 acquires the target image from a camera that captures a target, for example. The camera that captures the target image may use a camera external to the information processing system 10 (e.g., a camera mounted on a smartphone owned by a user, etc.) or may use a camera provided in the information processing system 10 (e.g., a camera disposed in a predetermined image capturing location). The target image acquired by the image acquisition unit 110 is configured to be outputted to the guide information generation unit 120.

The guide information generation unit 120 is configured to generate first guide information and second guide information, based on the target image acquired by the image acquisition unit 110. The first guide information indicates a current position of the face of the target person at the present time (i.e. when the target image is captured). The second guide information indicates a current angle of the face (i.e., a direction in which the face is facing) of the target person at the present time. The first guide information is generated by detecting the position of the face from the target image, for example. The second guide is generated by estimating the direction of the face detected from the target image. A specific example of the guide information will be described in detail in another example embodiment later. The first guide information and the second guide information generated by the guide information generation unit 120 are configured to be outputted to the display unit 130.

The display unit 130 is configured to display the first guide information (i.e., the guide information indicating the current position of the face of the target person) generated by the guide generation unit 120 and the second guide information (i.e., the guide information indicating the current angle of the face of the target person). The display unit 130 is configured to display third guide information and fourth guide information, together with the first guide information and the second guide information. The third guide information indicates a target position of the face of the target person. The fourth guide information indicates a target angle of the face of the target person. The target position and the target angle respectively indicated by the third guide information and the fourth guide information are set based on a position and an angle at which the face of the target person can be properly captured. The third guide information and the fourth guide information may be set in advance, for example, based on camera specifications or the like. In this instance, the third guide information and the fourth guide information may be stored in the storage apparatus 14 (see FIG. 1). Alternatively, the third guide information and the fourth guide information may be generated at each time in response to an image capture environment or the like (see a seventh example embodiment described later). The display unit 130 may display each piece of the guide information on a display provided in the output apparatus 16 (see FIG. 1), for example. Alternatively, the display unit 130 may display each piece of the guide information on a display external to the information processing system 10.

### Flow of Operation

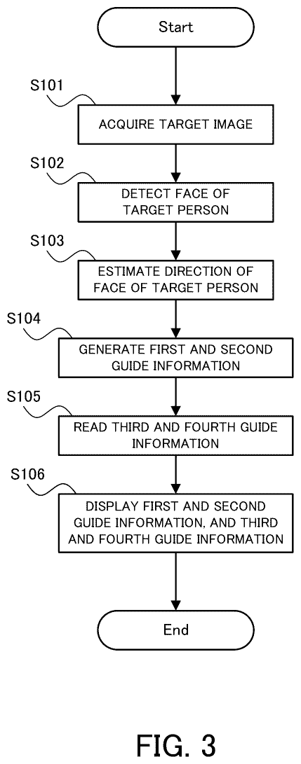

Next, a flow of operation by the information processing system 10 according to the first example embodiment will be described with reference to FIG. 3. FIG. 3 is a flowchart illustrating the flow of the operation of the information processing system according to the first example embodiment.

As illustrated in FIG. 3, when the operation of the information processing system 10 according to the first example embodiment is started, first, the image acquisition unit 110 acquires the target image including the face of the target person (step S101).

Subsequently, the guide information generation unit 120 detects the face of the target person from the target image (step S102). For example, the guide information generation unit 120 detects an area in which there is the face of the target person, in the target image. Then, the guide information generation unit 120 estimates the direction (angle) of the face from the detected face of the target person (step S103). Since existing techniques can be adopted, as appropriate, to a method of detecting the face and a method of estimating the direction of the face, a detailed description of the methods is omitted here.

Subsequently, the guide information generation unit 120 generates the first guide information and the second guide information, respectively based on the detected position of the face of the target person and the estimated direction of the face of the target person (step S104).

Subsequently, the display unit 130 reads the third guide information and the fourth guide information (step S105). Then, the display unit 130 displays the first guide information and the second guide information generated by the guide information generation unit 120, and the read third guide information and the read fourth guide information (step S106). Each piece of the guide information may continue being displayed until adjustment of the position and angle of the face of the target person is completed (e.g., until the position and angle of the face of the target person become the target position and angle).

The information processing system 10 may have a function of capturing the target person again after displaying/outputting each piece of the guide information. That is, the information processing system 10 may capture the face of the target person at the target position and at the target angle, by displaying each piece of the guide information. The information processing system 10 may end the display of each piece of the guide information in a case where the face of the target person can be captured at the target position and at the target angle.

### Technical Effect

Next, a technical effect obtained by the information processing system 10 according to the first example embodiment will be described.

As described in FIG. 1 to FIG. 3, in the information processing system 10 according to the first example embodiment, the third guide information and the fourth guide information indicating the target position and the target angle of the face are displayed, together with the first guide information and the second guide information indicating the current position and the current angle of the face of the target person. In this way, it is possible to properly guide the target person/user by comparing the current position and angle of the target person with the target position and angle of the face, and it is therefore possible to properly capture an image of the face of the target person.

### Second Example Embodiment

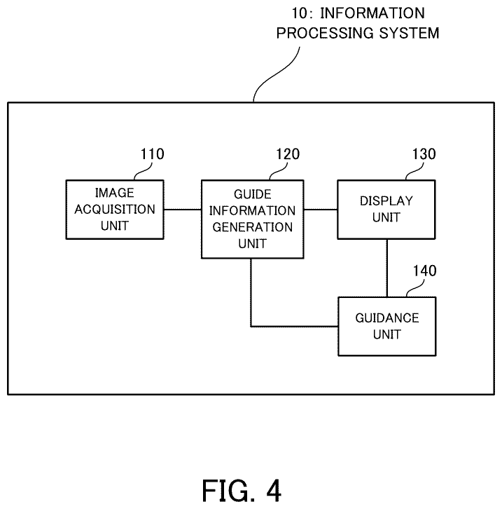

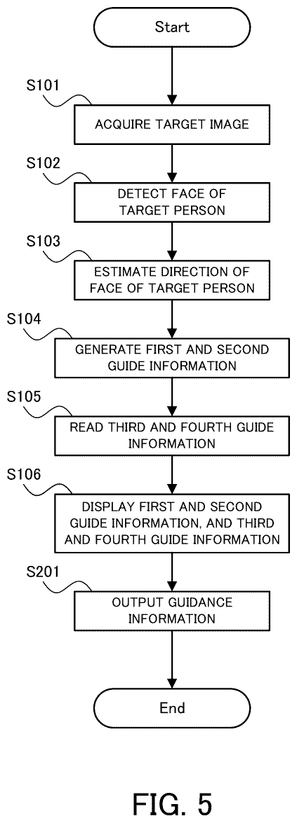

The information processing system 10 according to a second example embodiment will be described with reference to FIG. 4 and FIG. 5. The second example embodiment partially differs from the first example embodiment only in the configuration and operation, and may be the same as the first example embodiment in the other parts. For this reason, a part differing from the first example embodiment will be described in detail below, and a description of the other overlapping parts will be omitted as appropriate.

### Functional Configuration

First, a functional configuration of the information processing system 10 according to the second example embodiment will be described with reference to FIG. 4. FIG. 4 is a block diagram illustrating the functional configuration of the information processing system according to the second example embodiment. In FIG. 4, the same components as those illustrated in FIG. 2 carry the same reference numerals.

As illustrated in FIG. 4, the information processing system 10 according to the second example embodiment includes, as components for realizing the functions thereof, the image acquisition unit 110, the guide information generation unit 120, the display unit 130, and a guidance unit 140. That is, the information processing system 10 according to the second example embodiment further includes the guidance unit 140, in addition to the configuration in the first example embodiment (see FIG. 2). The guidance unit 140 may be a processing block realized by the processor 11 (see FIG. 1), for example.

The guidance unit 140 is configured to output guidance information for guiding a movement of the face of the target person. The guidance information is information for guiding the movement of the face of the target person such that the first guide information is superimposed on the third guide information and such that the second guide information is superimposed on the fourth guide information. The guidance information may be generated, for example, based on a degree of deviation between the first guide information and the third guide information (i.e., a degree of deviation between the current position of the face of the target person and the target position). The guidance information may be generated, for example, based on a degree of deviation between the second guide information and the fourth guide information (i.e., a degree of deviation between the current angle of the face of the target person and the target angle).

The guidance unit 140 may display the guidance information on the same display on which each piece of the guide information (i.e., the first to fourth guide information) is displayed. For example, the guidance unit 140 may display messages of “Please superimpose the first guide information on the third guide information” and “Please superimpose the second guide information on the fourth guide information”, on the display on which each piece of the guide information is displayed. Alternatively, the guidance unit 140 may display a message, an arrow, or the like indicating a direction in which the face should be moved to superimpose the first guide information on the third guide information, and indicating a direction in which the face should be moved to superimpose the second guide information on the fourth guide information, on the display on which each piece of the guide information is displayed. Alternatively, the guidance unit 140 may audio-output the guidance information. For example, the guidance unit 140 may audio-output the above various messages from a speaker disposed near the display on which each piece of the guide information is displayed.

### Flow of Operation

Next, with reference to FIG. 5, a flow of operation by the information processing system 10 according to the second example embodiment will be described. FIG. 5 is a flowchart illustrating the flow of the operation of the information processing system according to the second example embodiment. In FIG. 5, the same steps as those illustrated in FIG. 3 carry the same reference numerals.

As illustrated in FIG. 5, when the operation of the information processing system 10 according to the second example embodiment is started, first, the same processing as that in the steps S101 to S106 described in the first example embodiment is performed. That is, the image acquisition unit 110 acquires the target image including the face of the target person (step S101). The guide information generation unit 120 detects the face of the target person from the target image (step S102). The guide information generation unit 120 estimates the direction of the face from the detected face of the target person (step S103). The guide information generation unit 120 generates the first guide information and the second guide information, respectively based on the detected position of the face of the target person and the estimated direction of the face of the target person (step S104). The display unit 130 reads the third guide information and the fourth guide information (step S105). The display unit 130 displays the first guide information and the second guide information generated by the guide information generation unit 120, and the read third guide information and the read fourth guide information (step S106).

Thereafter, especially in the second example embodiment, the guidance unit 140 outputs the guidance information (step S201). The guidance unit 140 may continue outputting the guidance information until the adjustment of the position and angle of the face of the target person is completed (e.g., until the position and angle of the face of the target person become the target position and angle).

The information processing system 10 may have a function of capturing the target person again after outputting the guidance information. That is, the information processing system 10 may capture the face of the target person at the target position and at the target angle, by displaying the guidance information. The information processing system 10 may end the output of the guidance information in a case where the face of the target person can be captured at the target position and at the target angle.

### Technical Effect

Next, a technical effect obtained by the information processing system 10 according to the second example embodiment will be described.

As described in FIG. 4 and FIG. 5, in the information processing system 10 according to the second example embodiment, the guidance information for guiding the movement of the face of the target person is outputted such that the first guide information is superimposed on the third guide information and such that the second guide information is superimposed on the fourth guide information. In this way, it is possible to induce such a situation that the position and angle of the face of the target person become the target position and angle, by guiding the movement of the face of the target person.

### Third Example Embodiment

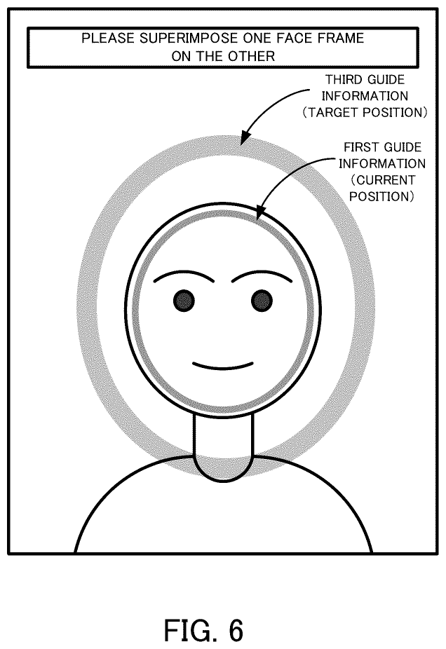

The information processing system 10 according to a third example embodiment will be described with reference to FIG. 6. The third example embodiment is an example embodiment for describing a display example of the first guide information and the third guide information, and may be the same as the first and second example embodiments in the configuration and operation of the system. For this reason, a part differing from each of the example embodiments described above will be described in detail below, and a description of the other overlapping parts will be omitted as appropriate.

### Display Example of Guide Information

First, with reference to FIG. 6, a specific example of the guide information in the information processing system 10 according to the third example embodiment will be described. FIG. 6 is a plan view illustrating the example of the guide information in the information processing system according to the third example embodiment.

As illustrated in FIG. 6, the guide information outputted by the information processing system 10 according to the third example embodiment is displayed in a frame border shape surrounding the face of the target person. The first guide information indicating the current position of the face of the target person is displayed as a frame border along the face of the target person. The third guide information indicating the target position is also displayed as a frame border of the same shape as that of the first guide information. A width of the frame border of the third guide information is displayed thicker than that of the frame border of the first guide information.

The first guide information and the third guide information are displayed together with the second guide information and the fourth guide information as described above, but here, for convenience of description, the second guide information and the fourth guide information are not illustrated. A display example of the second guide information and the fourth guide information will be described in detail in another example embodiment later.

In the example illustrated in FIG. 6, as an example of the guidance information outputted by the guidance unit 140, a message of “Please superimpose one face frame on the other” is displayed on a screen. Accordingly, the target person moves the face so as to superimpose the frame border of the first guide information on the frame border of the third guide information. Specifically, in the example illustrated in FIG. 6, the target person tries to superimpose the first guide information on the third guide information by bringing the face closer to the camera. (i.e., by moving such that the frame border of the first guide information becomes larger). As a consequence, a state in which the first guide information is superimposed on the third guide information, provides a position of the face suitable for capturing of an image of a target.

### Technical Effect

Next, a technical effect obtained by the information processing system 10 according to the third example embodiment will be described.

As described in FIG. 6, in the information processing system 10 according to the third example embodiment, the first guide information and the third guide information are displayed in the frame border shape having different thicknesses from each other. In this way, by moving the face so as to superimpose the first guide information on the third guide information, it is possible to easily bring the position of the face closer to the target position. Furthermore, since the width of the third guide information is displayed thicker than that of the first guide information, it is easier to superimpose the first guide information on the third guide information.

### Fourth Example Embodiment

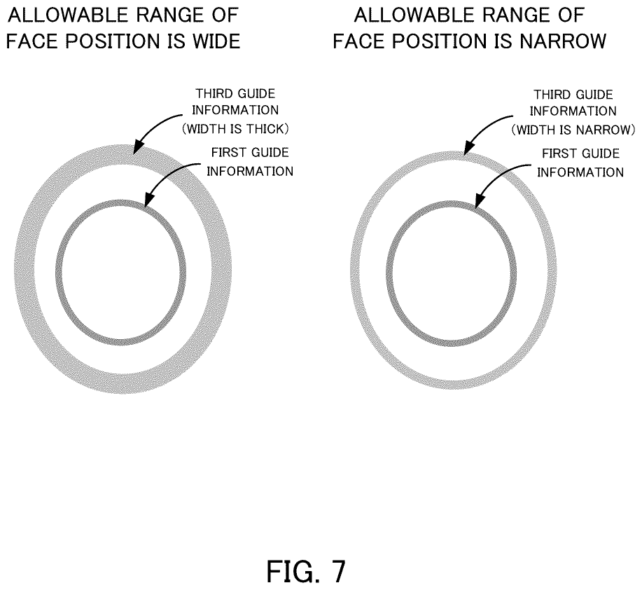

The information processing system 10 according to a fourth example embodiment will be described with reference to FIG. 7. The fourth example embodiment is an example embodiment for describing a method of setting the width of the frame border in the third example embodiment, and may be the same as the third example embodiment in the other parts. For this reason, a part differing from each of the example embodiments described above will be described in detail below, and a description of the other overlapping parts will be omitted as appropriate.

### Setting Width of Guide Information

First, with reference to FIG. 7, the method of setting the width of the guide information in the information processing system 10 according to the fourth example embodiment will be specifically described. FIG. 7 is a plan view illustrating an example of the guide information in the information processing system according to the fourth example embodiment.

As illustrated in FIG. 7, in the information processing system 10 according to the fourth example embodiment, the widths of the frame borders of the first guide information and the third guide information change depending on an allowable range for the target position of the face. Specifically, in a case where the allowable range for the position of the face is wide (i.e., in a case where an appropriate image can be captured even when the position is slightly shifted), the frame border of the third guide information is displayed thick. On the other hand, in a case where the allowable range for the position of the face is narrow (i.e., in a case where the position of the face is slightly shifted and an appropriate image cannot be captured), the frame border of the third information is displayed narrow. Described here are two examples in which the frame borders have different thicknesses, but the thickness of the frame border may be finely changed depending on the allowable range. That is, the thickness of the frame border of the third guide information may vary in three or more stages depending on the allowable range, or may vary linearly.

### Technical Effect

Next, a technical effect obtained by the information processing system 10 according to the fourth example embodiment will be described.

As described in FIG. 7, in the information processing system 10 according to the fourth example embodiment, the widths of the first guide information and the third guide information are determined depending on the allowable range for the target position of the face. In this way, it is easy to superimpose the first guide information on the third guide information in the allowable range. In other words, it is possible to prevent that the width of the target position indicated by the third guide information is too narrow to superimpose the first guide information on the third guide information.

### Fifth Example Embodiment

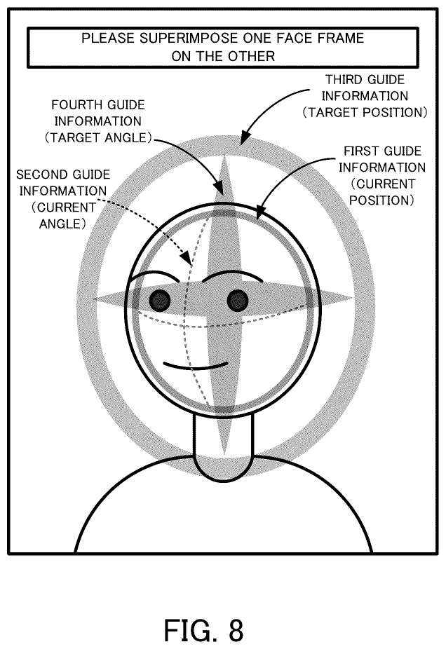

The information processing system 10 according to a fifth example embodiment will be described with reference to FIG. 8. The fifth example embodiment is an example embodiment for describing a display example of the second guide information and the fourth guide information, and may be the same as the first to fourth example embodiments in the configuration and operation of the system. For this reason, a part differing from each of the example embodiments described above will be described in detail below, and a description of the other overlapping parts will be omitted as appropriate.

### Display Example of Guide Information

First, with reference to FIG. 8, a specific example of the guide information in the information processing system 10 according to the fifth example embodiment will be described. FIG. 8 is a plan view illustrating the example of the guide information in the information processing system according to the fifth example embodiment.

As illustrated in FIG. 8, in the information processing system 10 according to the fifth example embodiment, the first guide information and the third guide information are displayed in the frame border shape surrounding the face of the target person. On the other hand, the second guide information and the fourth guide information are displayed in a cross-line shape, in the frame borders of the first guide information and the third guide information, respectively. More specifically, the second guide information indicating the current angle of the face of the target person is displayed in the cross-line shape extending longitudinally and laterally in the frame border of the first guide information. The fourth guide information indicating the target angle of the face is displayed in the cross-line shape extending longitudinally and laterally in the frame border of the third guide information. The width of the frame border of the fourth guide information is displayed thicker than that of the frame border of the second guide information.

The second guide information is displayed as a circular arc along a sphere corresponding to the face. Specifically, the second guide information is displayed as two circular arcs, each of which is obtained by connecting a tip of a normal vector of the face and respective one of horizontal and vertical rotation axes. Therefore, the shape of the circular arc changes depending on the direction of the face, and may indicate the angle of the face of the target person. Furthermore, in the fourth guide information, the width of the frame border/cross line is thicker as it is closer to a center (i.e., a part where the cross intersects). By changing the width of the cross line in this way, it is possible to more easily superimpose the second guide information on the fourth guide information.

In the example illustrated in FIG. 8, the target person moves the face so as to superimpose the frame border of the first guide information on the frame border of the third guide information. In addition, the target person moves the face so as to superimpose the cross line of the second guide information on the cross line of the fourth guide information. Specifically, in the example illustrated in FIG. 6, the target person tries to superimpose the second guide information on the fourth guide information by directing the front of the face to the camera. (i.e., by moving such that the cross line of the second guide information is in front). As a consequence, a state in which the second guide information is superimposed on the fourth guide information, provides an angle of the face suitable for capturing of an image of a target.

### Technical Effect

Next, a technical effect obtained by the information processing system 10 according to the fifth example embodiment will be described.

As described in FIG. 8, in the information processing system 10 according to the fifth example embodiment, the second guide information and the fourth guide information are displayed in the cross-line shape having different thicknesses from each other. In this way, by moving the face so as to superimpose the second guide information on the fourth guide information, it is possible to easily bring the angle of the face closer to the target angle. Furthermore, since the width of the fourth guide information is displayed thicker than that of the second guide information, it is easier to superimpose the second guide information on the fourth guide information.

### Sixth Example Embodiment

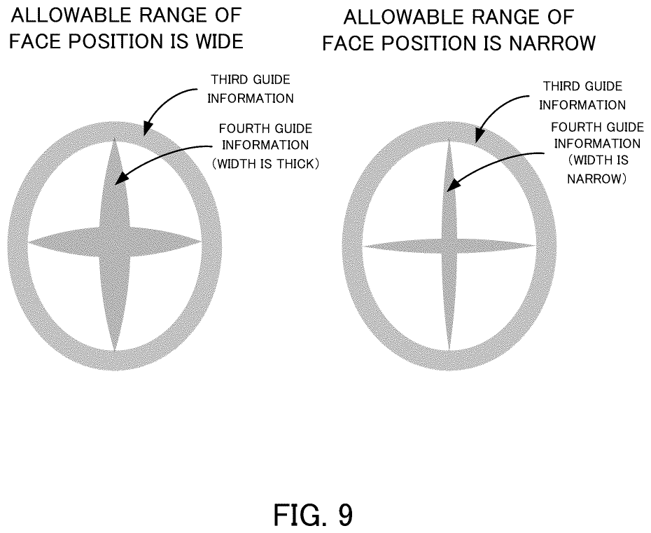

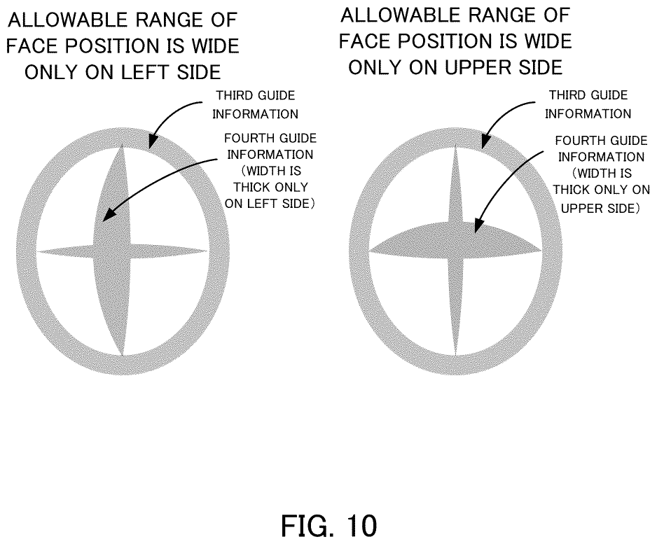

The information processing system 10 according to a sixth example embodiment will be described with reference to FIG. 9 and FIG. 10. The sixth example embodiment is an example embodiment for describing a method of setting the width of the cross line in the fifth example embodiment, and may be the same as the fifth example embodiment in the other parts. For this reason, a part differing from each of the example embodiments described above will be described in detail below, and a description of the other overlapping parts will be omitted as appropriate.

### Setting Width of Guide Information

First, with reference to FIG. 9, the method of setting the width of the guide information in the information processing system 10 according to the sixth example embodiment will be specifically described. FIG. 9 is version 1 of a plan view illustrating an example of the guide information in the information processing system according to the sixth example embodiment.

As illustrated in FIG. 9, in the information processing system 10 according to the sixth example embodiment, the widths of the frame borders of the second guide information and the fourth guide information change depending on an allowable range for the target angle of the face. Specifically, in a case where the allowable range for the angle of the face is wide (i.e., in a case where an appropriate image can be captured even when the angle is slightly shifted), the width of the cross line of the fourth guide information is displayed thick. On the other hand, in a case where the allowable range for the angle of the face is narrow (i.e., in a case where the angle is slightly shifted and an appropriate image cannot be captured), the width of the cross line of the fourth guide information is displayed narrow. Described here are two examples in which the cross lines have different thicknesses, but the thickness of the cross line may be finely changed depending on the allowable range. That is, the thickness of the cross line of the fourth guide information may vary in three or more stages depending on the allowable range, or may vary linearly.

### Modified Example

Next, with reference to FIG. 10, a modified example of the guide information in the information processing system 10 according to the sixth example embodiment will be described. FIG. 10 is version 2 of a plan view illustrating the example of the guide information in the information processing system according to the sixth example embodiment.

As illustrated in FIG. 10, the fourth guidance information in the information processing system 10 according to the sixth example embodiment may be asymmetrically shaped depending on a partial difference in the allowable range. Such a partial change in the width of the cross line makes it possible to properly guide the angle of the face, even when the allowable range varies depending on the direction.

The fourth guide information may be displayed such that the width of the cross line is wider in an area in which the allowable range is wide. Specifically, in a case where the allowable range is wide for a horizontal (i.e., lateral) angle of the face, a longitudinally extending line of the cross line may be displayed thick. For example, as illustrated in FIG. 10 (left), in a case where the allowable range of the angle of the face is wide only on a left side of the screen, the width may be thickened such that a longitudinal cross line swells/rises on a left side. Furthermore, in a case where the allowable range is wide for a vertical (i.e., longitudinal) angle of the face, a laterally extending line may be displayed thick. For example, as illustrated in FIG. 10 (right), in a case where the allowable range of the angle of the face is wide only on an upper side of the screen, the width may be thickened such that a lateral cross line swells/rises on an upper side. Described here is an example in which the allowable range is extended only in one direction, but in a case where the allowable range is extended in a plurality of directions, the thickness of the line may be changed in the plurality of directions. In this case, the thickness of both the longitudinally extending line and the laterally extending line of the cross line may be changed.

### Technical Effect

Next, a technical effect obtained by the information processing system 10 according to the sixth example embodiment will be described.

As described in FIG. 9 and FIG. 10, in the information processing system 10 according to the sixth example embodiment, the widths of the second guide information and the fourth guide information are determined depending on the allowable range for the target angle of the face. In this way, it is easy to superimpose the second guide information on the fourth guide information in the allowable range. In other words, it is possible to prevent that the width of the target angle indicated by the fourth guide information is too narrow to superimpose the second guide information on the fourth guide information.

### Seventh Example Embodiment

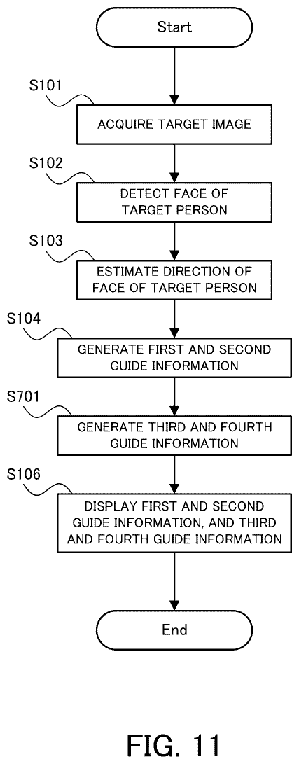

The information processing system 10 according to a seventh example embodiment will be described with reference to FIG. 11. The seventh example embodiment partially differs from the first example embodiment only in the operation, and may be the same as the first to sixth example embodiments in the other parts. For this reason, a part differing from the first example embodiment described above will be described in detail below, and a description of the other overlapping parts will be omitted as appropriate.

### Flow of Operation

First, with reference to FIG. 11, a flow of operation by the information processing system 10 according to the seventh example embodiment will be described. FIG. 11 is a flowchart illustrating the flow of the operation of the information processing system according to the seventh example embodiment. In FIG. 11, the same steps as those illustrated in FIG. 3 carry the same reference numerals.

As illustrated in FIG. 11, when the operation of the information processing system 10 according to the seventh example embodiment is started, first, the same processing as that in the steps S101 to S104 described in the first example embodiment is performed. That is, the image acquisition unit 110 acquires the target image including the face of the target person (step S101). The guide information generation unit 120 detects the face of the target person from the target image (step S102). The guide information generation unit 120 estimates the direction of the face from the detected face of the target person (step S103). The guide information generation unit 120 generates the first guide information and the second guide information, respectively based on the detected position of the face of the target person and the estimated direction of the face of the target person (step S104).

Especially in the seventh example embodiment, the guide information generation unit 120 generates the third guide information and the fourth guide information (step S701). The guide information generation unit 120 generates the third guide information and the fourth guide information, based on the target image. More specifically, the guide information generation unit 120 generates the third guide information and the fourth guide information suitable for an image capture environment, based on the image capture environment (e.g., brightness, etc.) estimated from the target image.

When the third guide information and the fourth guide information are generated, the display unit 130 displays each of the first guide information, the second guide information, the third guide information, and the fourth guide information generated by the guide information generation unit 120 (step S106).

### Technical Effect

Next, a technical effect obtained by the information processing system 10 according to the seventh example embodiment will be described.

As illustrated in FIG. 11, in the information processing system 10 according to the seventh example embodiment, the third guide information and the fourth guide information are generated based on the target image. In this way, it is possible to generate appropriate third guide information and fourth guide information, depending on the image capture environment of the current target image. Therefore, as compared with a case of using the third guide information and the fourth guide information prepared in advance, it is possible to more properly guide the target position and the target angle.

### Eighth Example Embodiment

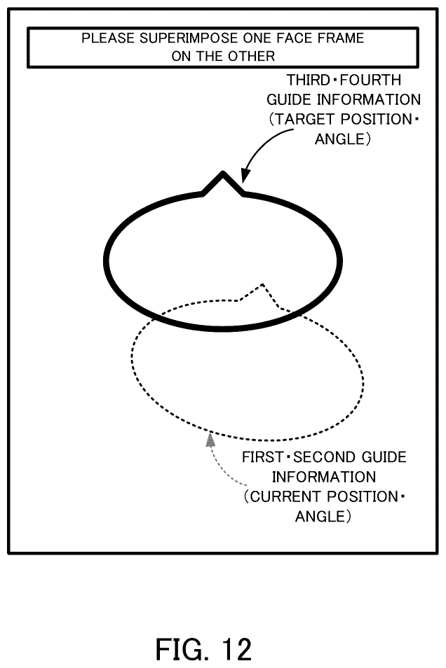

The information processing system 10 according to an eighth example embodiment will be described with reference to FIG. 12. The eighth example embodiment is an example embodiment for describing a display example of each piece of the guide information described above, and may be the same as the first to seventh example embodiments in the configuration and operation of the system. For this reason, a part differing from each of the example embodiments described above will be described in detail below, and a description of the other overlapping parts will be omitted as appropriate.

### Display Example of Guide Information

First, with reference to FIG. 12, a specific example of the guide information in the information processing system 10 according to the example embodiment will be described. FIG. 12 is a plan view illustrating the display example of the guide information in the information processing system according to the eighth example embodiment.

As illustrated in FIG. 12, the guide information outputted by the information processing system 10 according to the eighth example embodiment is displayed as information indicating the position and angle of the face of the target person when viewed from above. For example, each piece of the guide information is displayed in an elliptic shape with a part of a nose part protruding. The first guide information and the second guide information according to the eighth example embodiment are collectively displayed as one shape. Similarly, the third guide information and the fourth guide information according to the eighth example embodiment are also collectively displayed as one shape. The current position of the face of the target person indicated by the first guide information and the target position of the face indicated by the third guide information are expressed by the position and size of the ellipse. The current angle of the face of the target person indicated by the second guide information and the target angle of the face indicated by the fourth guide information are expressed by inclination of the ellipse and a position of the nose.

In the example illustrated in FIG. 12, the target person moves the face such that a frame border of the ellipse corresponding to the first guide information and the second guide information is superimposed on a frame border of the ellipse corresponding to the third guide information and the fourth guide information. Specifically, in the example illustrated in FIG. 12, the target person directs the front of the face to the camera and moves closer to the camera, thereby trying to superimpose the frame borders of the ellipses. At this time, the target person moves the face such that the nose parts also exactly match each other. As a consequence, a state in which the ellipse corresponding to the first guide information and the second guide information is superimposed on the ellipse corresponding to the third guide information and the fourth guide information, provides a position and angle of the face suitable for capturing of an image of a target.

### Technical Effect

Next, a technical effect obtained by the information processing system 10 according to the eighth example embodiment will be described.

As described in FIG. 12, in the information processing system 10 according to the eighth example embodiment, each piece of the guide information is displayed as information indicating the position and angle of the face of the target person when viewed from above. In this way, it is possible to confirm the current position and angle of the face and the target position and angle, from a direction different from a direction in which the target image is captured, and it is therefore possible to properly adjust the position and angle of the face. For example, it is possible to properly guide even the movement of the face in a depth direction, which is hard to understand from the front.

### Ninth Example Embodiment

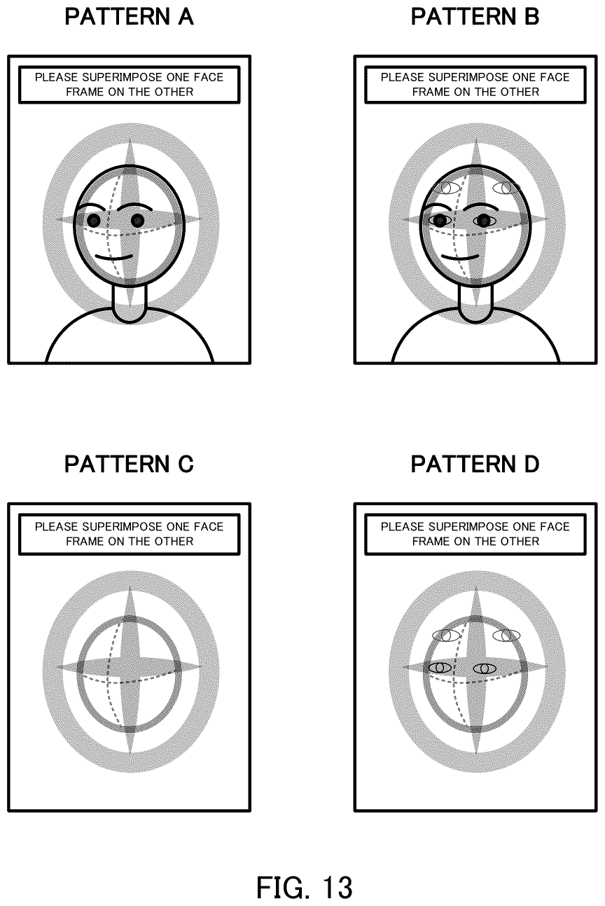

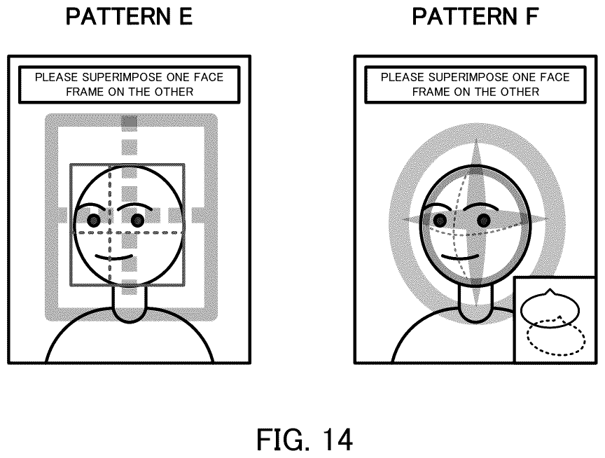

The information processing system 10 according to a ninth example embodiment will be described with reference to FIG. 13 and FIG. 14. The ninth example embodiment is an example embodiment for describing a display pattern of each piece of the guide information, and may be the same as the other example embodiments in the configuration and operation of the system. For this reason, a part differing from each of the example embodiments described above will be described in detail below, and a description of the other overlapping parts will be omitted as appropriate.

### Display Pattern of Guide Information

Hereinafter, with reference to FIG. 13 and FIG. 14, display patterns of the guide information in the information processing system 10 according to the ninth example embodiment will be described. FIG. 13 is version 1 of a plan view illustrating display examples of the guide information in the information processing system according to the ninth example embodiment. FIG. 14 is version 2 of a plan view illustrating display examples of the guide information in the information processing system according to the ninth example embodiment.

Pattern A illustrated in FIG. 13 is a pattern for superimposing and displaying each piece of the guide information on the target image. The display in this way makes it possible to move the face while confirming both actual face movement and movement of the guide information.

Pattern B is a pattern in which parts corresponding to eye positions are added to each piece of the guide information guide information, in addition to the display of Pattern A. The display in this way makes it possible to express face-likeness better in each piece of the guide information. It is also easier to make adjustment by moving the face such that eye parts in one piece of the guide information are superimposed on those in the other piece. In this example, the parts corresponding to the eyes are displayed; however, parts other than the eyes (e.g., parts corresponding to nose, ear, mouth, etc.) may be displayed.

Pattern C is a pattern that does not display the target image of Pattern A, but only displays each piece of the guide information. In this way, it is possible to prevent that each piece of the guide information is superimposed on the target image and that it is thus hard to see an image. In the present example embodiment, the first guide information and the second guide information respectively indicating the current position and angle of the face of the target person are displayed. Therefore, even if an actual face image is not displayed, the position of the face is properly adjustable.

Pattern D is a pattern that does not display the target image of Pattern B, but only displays each piece of the guide information. Even in this case, the same effect as that of the pattern C described above can be obtained.

Pattern E illustrated in FIG. 14 is a pattern that displays the first guide information and the third guide information in a rectangular shape. As described above, the frame border of the face does not need to be in a shape along the contour of the face. That is, there is no particular limitation on the shapes of the first guide information and the third guide information, and there may be a variety of shapes.

Pattern F is a pattern that displays, on a lower right side of Pattern A, the guide information indicating the position and angle of the face of the target person when viewed from above (see the eighth example embodiment and FIG. 12). The display in this way makes it possible to move the face while confirming both a state viewed from the front, and a state viewed from above.

### Tenth Example Embodiment

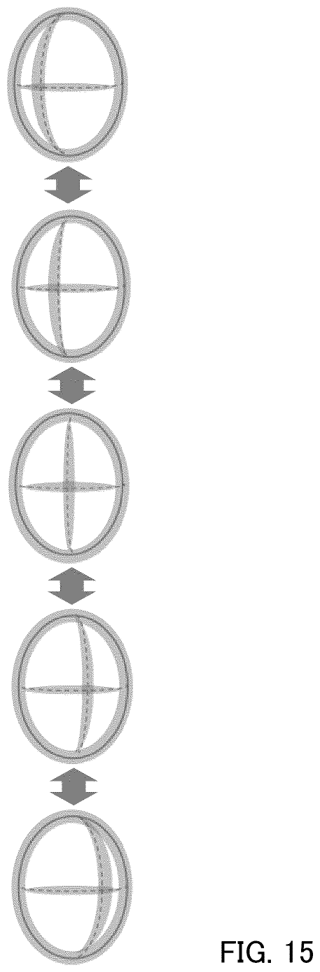

The information processing system 10 according to a tenth example embodiment will be described with reference to FIG. 15. The tenth example embodiment is an example embodiment for describing an example of changing the display of each piece of the guide information, and may be the same as the other example embodiments in the configuration and operation of the system. For this reason, a part differing from each of the example embodiments described above will be described in detail below, and a description of the other overlapping parts will be omitted as appropriate.

### Head Shake Guidance

With reference to FIG. 15, head shake guidance using the guide information will be described. FIG. 15 is a plan view illustrating a display example of the guide information in the information processing system according to the tenth example embodiment.

As illustrated in FIG. 15, in the information processing system 10 according to the tenth example embodiment, the movement of the face of the target person is guided by gradually changing the fourth guidance information indicating the target angle of the face. For example, a state in which the face is directed to the left is set as the target angle. Then, the target angle is gradually moved to the front. Finally, a state in which the face is directed to the right is set as the target angle. In this way, it is possible to encourage the target person to perform an action of rotating the face from the left to the right. Then, by repeatedly performing such display, it is possible to encourage the target person to perform an action of shaking the head from side to side. Such a head shake action may be performed as a part of the liveness determination, for example.

When the target person is encouraged to perform the head shake action, a message such as “Please move the face such that one face frame is superimposed on the other” may be displayed as the guidance information outputted by the guidance unit 140.

### Eleventh Example Embodiment

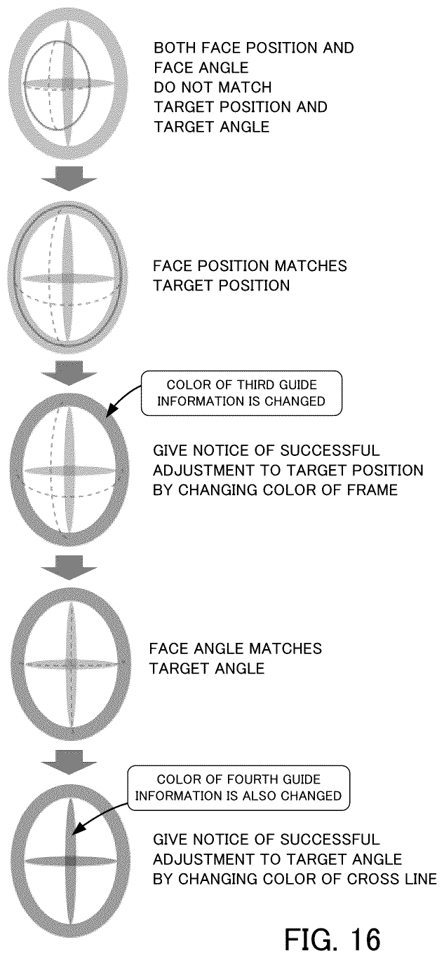

The information processing system 10 according to an eleventh example embodiment will be described with reference to FIG. 16. The eleventh example embodiment is an example embodiment for describing an example in which the display of each piece of the guide information is changed, as in the tenth example embodiment, and may be the same as the other example embodiments in the configuration and operation of the system. For this reason, a part differing from each of the example embodiments described above will be described in detail below, and a description of the other overlapping parts will be omitted as appropriate.

### Color Change in Guide Information

With reference to FIG. 16, a display example of changing a color of the guide information will be described. FIG. 16 is a plan view illustrating the display example of the guide information in the information processing system according to the eleventh example embodiment.

As illustrated in FIG. 16, in the information processing system 10 according to the tenth example embodiment, in a case where a piece of the guide information is superimposed on the other, the color of each piece of the guide information is changed. For example, when a state in which the position and angle of the face do not match the target position and the target angle (i.e., a state in which the first guide information is not superimposed on the third guide information, and in which the second guide information is not superimposed on the fourth guide information) is changed to a state in which only the position of the face matches the target position (i.e., a state in which the first guide information is superimposed on the third guide information, and in which the second guide information is not superimposed on the fourth guide information), the color of the third guide information indicating the target position of the face is changed. In this way, the target person moving the face according to the guide information, can intuitively grasp that the position of the face matches the target position.

Thereafter, when the state is changed to a state in which the angle of the face also matches the target angle (i.e., a state in which the first guide information is superimposed on the third guide information, and in which the second guide information is also superimposed on the fourth guide information), the color of the fourth guide information indicating the target angle of the face is changed. In this way, target person moving the face according to the guide information, can intuitively grasp that the angle of the face matches the target angle.

In the above example, the position of the face and the angle of the face match the target in this order; however, even in a case where the angle of the face and the position of the face match the target in this order, the color of the guide information may be sequentially changed. Specifically, first, when the angle of the face matches the target angle, the color of the fourth guide information indicating the target angle is changed, and then, when the position of the face matches the target position, the color of the third guide information indicating the target position may be changed.

Furthermore, in the above example, a user may be notified of the matching of the pieces of the guide information by changing the color of the guide information, but other than the color change may be used to notify the user of the matching of the pieces of the guide information. For example, the user may be notified of the matching of the pieces of the guide information, by displaying a message or outputting sound effects.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### SUPPLEMENTARY NOTES

The example embodiments described above may be further described as, but not limited to, the following Supplementary Notes below.

### Supplementary Note 1

An information processing system according to Supplementary Note 1 is an information processing system including: an acquisition unit that acquires a target image including a face of a target person; a generation unit that generates first guide information indicating a current position of the face of the target person and second guide information indicating a current angle of the face of the target person, based on the target image; and a display unit that displays third guide information indicating a target position of the face of the target person and fourth guide information indicating a target angle of the face of the target person, together with the first guide information and the second guide information.

### Supplementary Note 2

An information processing system according to Supplementary Note 2 is the information processing system according to Supplementary Note 1, further including a guidance unit that outputs guidance information for guiding a movement of the face of the target person such that the first guide information is superimposed on the third guide information and such that the second guide information is superimposed on the fourth guide information.

### Supplementary Note 3

An information processing system according to Supplementary Note 3 is the information processing system according to Supplementary Note 1 or 2, wherein the first guide information and the third guide information are in a frame border shape corresponding to a position of the face, and a width of the third guide information is thicker than that of the first guide information.

### Supplementary Note 4

An information processing system according to Supplementary Note 4 is the information processing system according to Supplementary Note 3, wherein the width of the third guide information is determined based on a first allowable range set for the target position of the face of the target person.

### Supplementary Note 5

An information processing system according to Supplementary Note 5 is the information processing system according to Supplementary Note 1 or 2, wherein the second guide information and the fourth guide information are in a cross-line shape extending in two axial directions indicating an angle of the face, and a width of the fourth guide information is thicker than that of the second guide information.

### Supplementary Note 6

An information processing system according to Supplementary Note 6 is the information processing system according to Supplementary Note 5, wherein the width of the fourth guide information is determined based on a second allowable range set for the target angle of the face of the target person.

### Supplementary Note 7

An information processing system according to Supplementary Note 7 is the information processing system according to any one of Supplementary Notes 1 to 6, wherein the generation unit generates the third guide information and the fourth guide information, in addition to the first guide information and the second guide information, based on the target image.

### Supplementary Note 8

An information processing system according to Supplementary Note 8 is the information processing system according to any one of Supplementary Notes 1 to 7, wherein the display unit displays the first guide information, the second guide information, the third guide information, and the fourth guide information, as information indicating a position and an angle of the face of the target person when viewed from above.

### Supplementary Note 9

An information processing method according to Supplementary Note 9 is an information processing method that is executed by at least one computer, the information processing method including: acquiring a target image including a face of a target person; generating first guide information indicating a current position of the face of the target person and second guide information indicating a current angle of the face of the target person, based on the target image; and displaying third guide information indicating a target position of the face of the target person and fourth guide information indicating a target angle of the face of the target person, together with the first guide information and the second guide information.

### Supplementary Note 10

A recording medium according to Supplementary Note 10 is a recording medium on which a computer program that allows at least one computer to execute an information processing method is recorded, the information processing method including: acquiring a target image including a face of a target person; generating first guide information indicating a current position of the face of the target person and second guide information indicating a current angle of the face of the target person, based on the target image; and displaying third guide information indicating a target position of the face of the target person and fourth guide information indicating a target angle of the face of the target person, together with the first guide information and the second guide information.

### Supplementary Note 11

A computer program according to Supplementary Note 11 is a computer program that allows at least one computer to execute an information processing method, the information processing method including: acquiring a target image including a face of a target person; generating first guide information indicating a current position of the face of the target person and second guide information indicating a current angle of the face of the target person, based on the target image; and displaying third guide information indicating a target position of the face of the target person and fourth guide information indicating a target angle of the face of the target person, together with the first guide information and the second guide information.

The present disclosure is allowed to be changed, if desired, without departing from the essence or spirit of this disclosure which can be read from the claims and the entire specification. An information processing system, an information processing method, and a recording medium with such changes are also intended to be within the technical scope of the present disclosure.

### DESCRIPTION OF REFERENCE CODES

10 Information processing system
11 Processor
110 Image acquisition unit
120 Guide information generation unit
130 Display unit
140 Guidance unit

What is claimed is:

1. An information processing system comprising:
at least one memory that is configured to store instructions; and
at least one processor that is configured to execute the instructions to:
acquire a target image including a face of a target person;
generate first guide information indicating a current position of the face of the target person and second guide information indicating a current angle of the face of the target person, based on the target image; and
display third guide information indicating a target position of the face of the target person and fourth guide information indicating a target angle of the face of the target person, together with the first guide information and the second guide information.

2. The information processing system according to claim 1, wherein the at least one processor is configured to execute the instructions to output guidance information for guiding a movement of the face of the target person such that the first guide information is superimposed on the third guide information and such that the second guide information is superimposed on the fourth guide information.

3. The information processing system according to claim 1, wherein
the first guide information and the third guide information are in a frame border shape corresponding to a position of the face, and
a width of the third guide information is thicker than that of the first guide information.

4. The information processing system according to claim 3, wherein the width of the third guide information is determined based on a first allowable range set for the target position of the face of the target person.

5. The information processing system according to claim 1, wherein
the second guide information and the fourth guide information are in a cross-line shape extending in two axial directions indicating an angle of the face, and
a width of the fourth guide information is thicker than that of the second guide information.

6. The information processing system according to claim 5, wherein the width of the fourth guide information is determined based on a second allowable range set for the target angle of the face of the target person.

7. The information processing system according to claim 1, wherein the at least one processor is configured to execute the instructions to generate the third guide information and the fourth guide information, in addition to the first guide information and the second guide information, based on the target image.

8. The information processing system according to claim 1, wherein the at least one processor is configured to execute the instructions to display the first guide information, the second guide information, the third guide information, and the fourth guide information, as information indicating a position and an angle of the face of the target person when viewed from above.

9. An information processing method that is executed by at least one computer, the information processing method comprising:
acquiring a target image including a face of a target person;
generating first guide information indicating a current position of the face of the target person and second guide information indicating a current angle of the face of the target person, based on the target image; and
displaying third guide information indicating a target position of the face of the target person and fourth guide information indicating a target angle of the face of the target person, together with the first guide information and the second guide information.

10. A non-transitory recording medium on which a computer program that allows at least one computer to execute an information processing method is recorded, the information processing method including:
acquiring a target image including a face of a target person;
generating first guide information indicating a current position of the face of the target person and second guide information indicating a current angle of the face of the target person, based on the target image; and
displaying third guide information indicating a target position of the face of the target person and fourth guide information indicating a target angle of the face of the target person, together with the first guide information and the second guide information.
